(19) United States
(12) Patent Application Publication
(10) Pub. No.: US 2002/0105480 A1
(43) Pub. Date: Aug. 8, 2002

(54) Three-dimensional large screen display

(75) Inventors: Brian C. Lowry, Emlenton, PA (US); Jerald F. Lowry, Pittsburgh, PA (US); Evan Wimer, Pittsburgh, PA (US)

Correspondence Address: PEPPER HAMILTON LLP, 50th Floor, One Mellon Center, Pittsburgh, PA, 15219, US

(73) Assignee: Transvision, Inc.

(21) Appl. No.: 10/051,212

(22) Filed: Jan. 18, 2002

Related U.S. Application Data
(60) Provisional application No. 60/263,085, filed on Jan. 19, 2001.

(51) Int. Cl. G09G 5/00

(52) U.S. Cl. 345/6

(57) ABSTRACT

A large screen display system includes a mounting grid and an array of electro-optical display tile modules arranged to form a three-dimensional shape. The system includes a mounting frame formed into a three-dimensional configuration such as a whole or partial cylinder, sphere, cone, pyramid, box, or combinations thereof, or any other three-dimensional geometric configuration. The array of electro-optical display tile modules is in electrical communication with a computing or electronic processing device, such as a computer. The computer is equipped with a specialized video card for apportioning a composite video image into a plurality of segments and communicating each video image segment to a corresponding electro-optical display tile module such that the array of electro-optical display tile modules reconstitutes and displays the composite video image.

### CLAIM OF PRIORITY

This application claims priority to United States Provisional Patent Application No. 60/263,085, filed Jan. 19, 2001, which is incorporated by reference in its entirety.

### FIELD OF THE INVENTION

This application relates to large screen image display devices. More particularly, this application relates to devices that display images in three dimensions.

### BACKGROUND OF THE INVENTION

Large screen display (“LSD”) technology enables the dynamic display of interactive and non-interactive video content to large audiences. Applications of LSD technology are diverse and include public venues such as sports stadia, airports, large retail stores, and shopping malls. The wide range of applications serves a large and diverse market.

With the development and deployment of LSD technology comes the opportunity for further refinement and improvement of the apparatus and business methods that support the technology. Significant enhancements made to state-of-the-art LSD apparatus and business methods will likely generate an even wider range of applications and opportunities for deployment.

Existing techniques for displaying video images typically provide either flat or contoured display surfaces that are mounted to a support structure such as a wall or framework. None of these techniques provides for displaying a video image in multiple directions simultaneously. For example, a wall-mounted display can only display video images in an outward direction from the wall. Even a contoured LSD displays only a portion of the total image in any given direction. There is a need for an improved way to display video images in multiple directions simultaneously.

In addition, none of the existing techniques for displaying video images provides a video display surface forming a simple three-dimensional geometric shape such as a cylinder, sphere, pyramid, cone, or cube. A cylindrical display surface, for example, would be ideal for displaying a video image of a static or rotating cylindrical object such as a beverage or soup can. There is a need for a way to form video display surfaces into simple three-dimensional geometric shapes.

### SUMMARY OF THE INVENTION

A preferred embodiment of the invention is a large screen display comprising a three-dimensional mounting structure and a plurality of electro-optical display tile modules attached to the mounting structure. The plurality of tile modules form a display surface having a three dimensional shape such as a whole or partial cylinder, pyramid, egg-shape, cone, truncated cone, box, and/or sphere. The invention also includes a computing device that is in electronic communication with the tile modules.

Optionally, the computing device includes a processor and a video card that are capable of apportioning a video image into a plurality of video segments and delivering each of the video segments to one of the tile modules, and the tile modules are capable of displaying the video segments so that the tile modules collectively reconstitute the video image to form a reconstructed video image. The processor and video card may further be capable of systematically cycling the plurality of video segments from one tile module to another so that the reconstituted video image, when formed on the display, appears to be moving.

Also optionally, the display includes a base assembly on which the three-dimensional mounting structure is supported. Such a base assembly is preferably capable of moving the mounting structure, such as by rotating the mounting structure. As an additional option, the plurality of electro-optical display tile modules are detachably affixed to the mounting structure. Each electro-optical display tile module may comprise a display surface, an array of optical fibers in optical communication with the display surface, and a micro-display in electronic communication with a video input cable. In such an embodiment, the display surface of each tile module is preferably contoured to match a contour of the mounting structure. Also, each micro-display preferably is capable of converting a video signal received from the video input cable into light and transmitting the light to the array of optical fibers.

### BRIEF DESCRIPTION OF THE DRAWINGS

FIG. 1 is a side view of an LSD system having a video display surface forming a simple geometric shape.

FIG. 2 is a sectional view of the LSD system shown in FIG. 1 taken through section A-A.

FIG. 3 is an electro-optical display tile module.

FIG. 4 is a sectional view of the LSD system shown in FIG. 1 taken along section B-B in FIG. 2.

### DETAILED DESCRIPTION OF PREFERRED EMBODIMENTS OF THE INVENTION

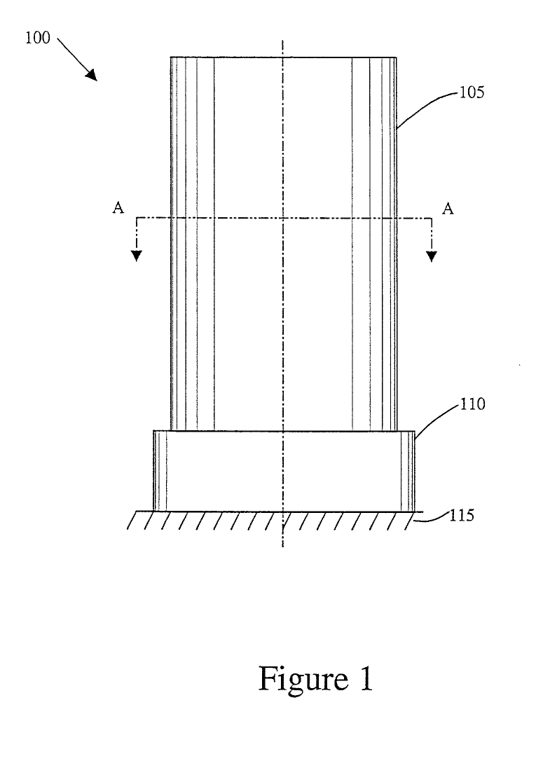

Referring to FIG. 1, in accordance with a preferred embodiment, a side view of a large screen display (“LSD”) system 100 includes a module assembly 105, a solid mounting surface 115 and a base assembly 110.

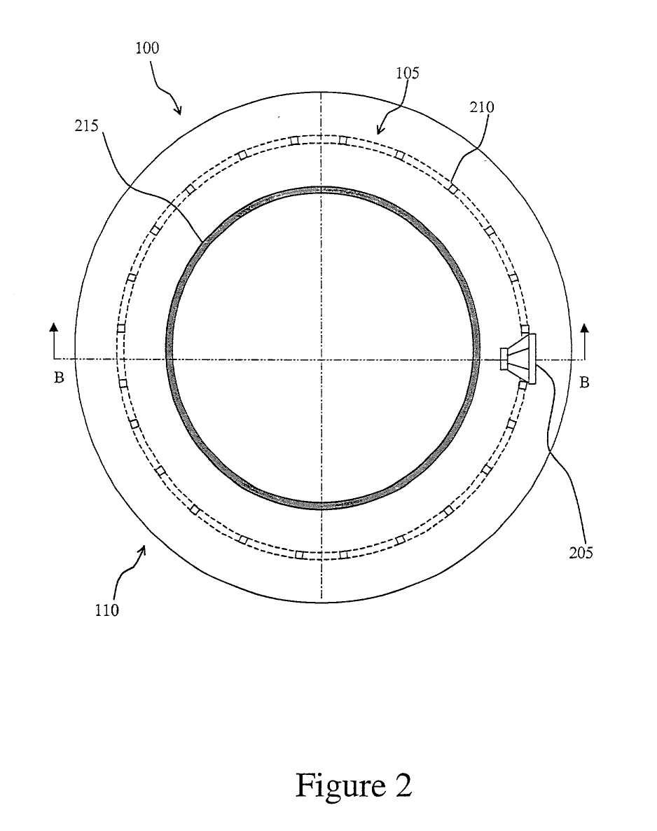

Module assembly 105 is a three-dimensional shape, such as optionally and preferably cylindrical and concentric as shown in FIG. 2. Module assembly 105 and base assembly 110 are rigidly affixed to each other. Cross sectional shapes other than circular, such as oval, semi-circular, or square, for example, and three-dimensional shapes such as pyramids, spheres, cones, and cubes are all acceptable so long as the module assembly and base assembly are designed so that the base assembly engages the module assembly. Base assembly 110 is positioned on a solid mounting surface 115 such as a floor or roof of a building, a balcony, mezzanine, or some other rigid part of a building, or a base or pedestal placed on the ground. Alternatively, base assembly 110 and module assembly 105 may be inverted and suspended (for example) from a solid mounting surface 115 such as a floor or roof of a building, or a balcony, mezzanine, or some other rigid part of a building. Alternatively, solid mounting surface 115 may be a flotation device that enables LSD system 100 to float on any body of water such as a lake, pond, reservoir, or indoor or outdoor decorative pool or swimming pool.

Referring to FIG. 2, a sectional view of LSD system 100 taken through section A-A in FIG. 1, the exemplary cross-sectional shape of module assembly 105 is circular. As noted above, other shapes such as square, oval, semicircular, triangular, polygonal, and others are acceptable. Module assembly 105 further includes an array of electro-optical display tile modules 205 (only one shown for simplicity), a mounting frame 210, and a raceway 215.

The exemplary illustrated raceway 215 is cylindrical, is attached to base assembly 110, and is concentric to mounting frame 210. Optionally, other shapes corresponding to the shape of the mounting frame may be used. Each electro-optical display tile module 205 is connected to mounting frame 210 in such a way that it is readily demountable from frame 210. This configuration allows easy access for maintenance purposes. Mounting frame 210 provides a cylindrical grid on which to demountably affix electro-optical display tile modules 205 using commonly available fasteners (not shown) such as self-locking pushpins or machine screws. In one example, each electro-optical display tile module 205 is demountably affixed to mounting frame 210 using fasteners requiring a corresponding release tool to reduce the possibility of, and preferably prevent, theft of display tile modules 205.

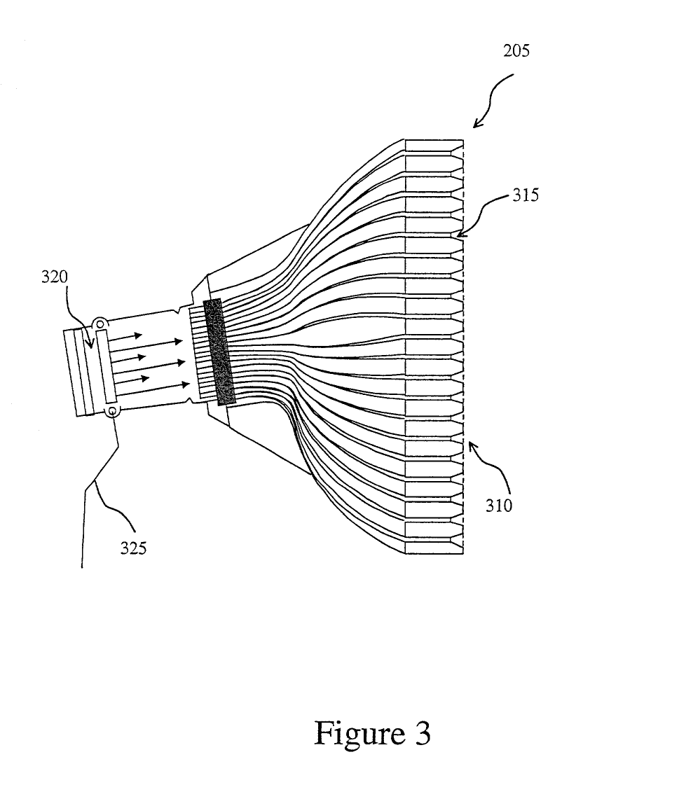

Referring to FIG. 3, an electro-optical display tile module 205 includes a display surface 310, an array of optical fibers 315 optically connected to display surface 310, a micro-display 320 which converts a video signal (not shown) into light, said light forming video images which are transmitted to the array of optical fibers 315, and a video input cable 325 connected to the micro-display 320 for the purpose of relaying a video signal to micro-display 320. In one example of the present invention, display surface 310 is contoured to match the contour of mounting frame 210.

A method for manufacturing and using modular optical fiber display tiles 205 is fully shown and described in U.S. Utility Pat. No. 6,304,703 entitled “Tiled Fiber Optic Display Apparatus,” and also in application Ser. No. 09/569,811 entitled “Micro-Display Driven Tiled Electro-Optic Display Apparatus” and in application Ser. No. 09/718,745 entitled “A Large Screen Fiber Optic Display With High Fiber Density and Method for its Rapid Assembly,” all of which are commonly owned and assigned and are incorporated herein by reference in their entirety, which show and describe the manufacture, assembly, and deployment of electro-optical display tile modules.

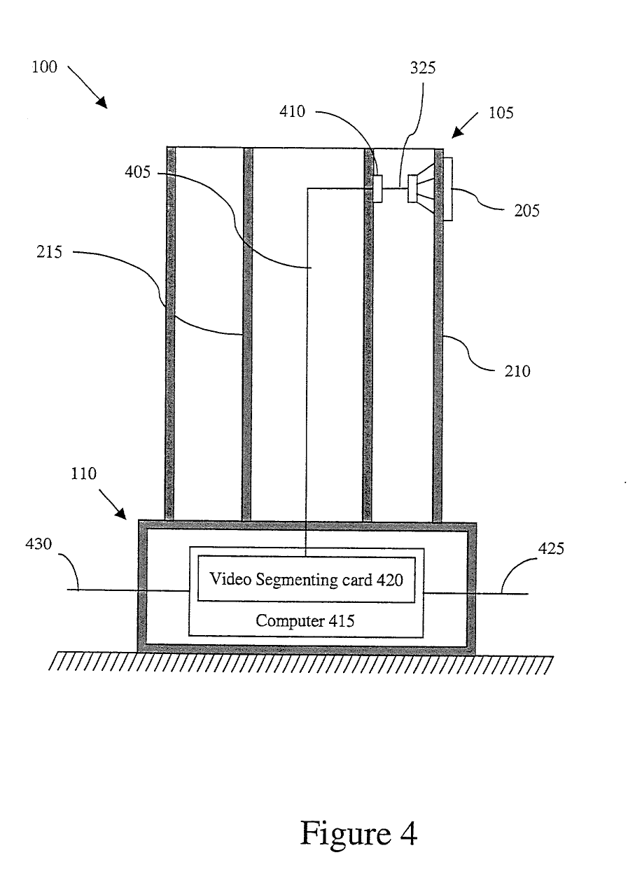

Referring to FIG. 4, module assembly 105 further includes an array of raceway video cables 405 (one shown for simplicity). Each raceway video cable 405 further includes a separable connector 410. Base assembly 110 further includes a computer 415 or other electronic computing or processing device, a video segmenting device 420 such as a specialized video card, a communication cable 425, and a power cable 430.

In operation, each video input cable 325 electrically connects to a raceway video cable 405 via a separable connector 410. This allows for easy removal of an electro-optical display tile module 205 from module assembly 105. Each raceway video cable 405 electrically connects to video segmenting card 420. Video segmenting card 420 is integrated into computer 415, for the purpose of apportioning the video image and distributing the video image segments to electro-optical display tile modules 205, via raceway video cables 405, connectors 410, and video input cables 235 respectively. Communication pathway 425 electrically connects computer 415 to an electronic data source (not shown), such as the Internet, a local area network (“LAN”), or any other type of network, or to a digital video disc (“DVD”) player, a video camera, or any type of electronic device capable of capturing, storing, and downloading images or data for presentation on a large screen display. Power line 430 electrically connects computer 415 to an electrical power source for the purpose of supplying required power to computer 415.

As an example of using this invention to display a video image, consider a video image of a rotating cylindrical object such as a beverage can. To display such a video image on module assembly 105, computer 415 receives a video image file through communication line 425 in a standard format such as that commonly known as Moving Pictures Experts Group (“MPEG”). This video image of the beverage can appears on a flat screen as if the actual can had been sliced down one side and flattened from three-dimensional space into two-dimensional space. Further, the video image moves on a flat screen from left to right such that as the image moves off the screen on the right, it reappears on the left side of the screen. Video segmenting card 420 electronically apportions the video image and distributes the video image segments through raceway video cables 405, connectors 410, and video input cables 235 to electro-optical display tile modules 205 such that an enlarged video image of the beverage can appears to rotate about the longitudinal axis of module assembly 105. Computer 415 can receive and display images of any cylindrical object, for example any type of food or beverage container, rolls of tape, paper towels, or bath tissue, rolls of coins, rolled candy, etc. in a similar manner. The displayed image may be static or may appear to rotate.

The displayed image may be given apparent motion either by rotating the displayed image electronically or rotating the entire display mechanically, as in rotating the cylindrical module assembly 105 around its longitudinal axis while the base assembly 110 remains fixed.

In other examples of this invention, module assembly 105 is formed in the shape of a cube, sphere, cone, truncated cone, or box of any arbitrary shape, or composite shapes such as a small cylinder on top of a large cylinder to represent a bottle with a neck.

The advantages of this invention include one or more of the following. A first advantage of this invention is that it displays a video image in multiple directions simultaneously. A second advantage of this invention is that it can be placed in the center of a room and display a video image such that all viewers in the room have the same perspective of the video image. A third advantage of this invention is that it allows an LSD system to take the form of a three dimensional geometric shape such as a cylinder, cone, cube, pyramid, sphere or box, or any combination of these elements. A fourth advantage of this invention is that it enables the display of a three-dimensional object onto a proportionally scaled, similarly shaped optical display screen surface without distortion.

It is to be understood that the invention is not limited in its application to the details of construction and to the arrangements of the components set forth herein or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the concept upon which this application is based may readily be utilized as a basis for the design of other structures, methods and systems for carrying out the several purposes of this invention. Further, since numerous modifications and variations will readily occur to those skilled in the art, the invention is not limited to the exact construction and operation illustrated and described, and accordingly, all appropriate modifications and equivalents fall within the scope of this invention.

The invention claimed is:

1. A large screen display, comprising:
a three-dimensional mounting structure;
a plurality of electro-optical display tile modules attached to the mounting structure, the plurality of tile modules forming a display surface having a three dimensional shape; and
a computing device in electronic communication with the tile modules.

2. The display of claim 1 wherein:
the computing device includes a processor and a video card;
the processor and video card are capable of apportioning a video image into a plurality of video segments and delivering each of the video segments to one of the tile modules; and
the tile modules are capable of displaying the video segments so that the tile modules collectively reconstitute the video image to form a reconstructed video image.

3. The display of claim 1 wherein the three dimensional shape comprises a whole or partial cylinder, pyramid, egg-shape, cone, truncated cone, box, sphere, or any combination thereof.

4. The display of claim 1 further comprising a base assembly on which the three-dimensional mounting structure is supported.

5. The display of claim 4 wherein the base assembly is capable of moving the mounting structure.

6. The display of claim 4 wherein the base assembly is capable of rotating the mounting structure.

7. The display of claim 1 wherein the plurality of electro-optical display tile modules is detachably affixed to the mounting structure.

8. The display of claim 2 wherein the processor and video card are further capable of systematically cycling the plurality of video segments from one tile module to another so that the reconstituted video image, when formed on the display, appears to be moving.

9. The display of claim 1 wherein each electro-optical display tile module comprises:
a display surface;
an array of optical fibers in optical communication with the display surface; and
a micro-display in electronic communication with a video input cable.

10. The display of claim 9 wherein the display surface of each tile module is contoured to match a contour of the mounting structure.

11. The display of claim 9 wherein each micro-display is capable of converting a video signal received from the video input cable into light and transmitting the light to the array of optical fibers.

12. A three-dimensional large screen display, comprising:
a three-dimensional mounting structure;
a base assembly which supports the mounting structure;
a plurality of electro-optical display tile modules detachably affixed to the mounting structure, each electro-optical display tile module comprising a display surface, an array of optical fibers in optical communication with the display surface, and a micro-display in electronic communication with a video input cable, the plurality of tile modules forming a display surface having a three dimensional shape; and
a computing device in electronic communication with the tile modules.

13. The display of claim 12 wherein the computing device includes a processor and a video card, and the processor and video card are capable of apportioning a video image into a plurality of video segments and delivering each of the video segments to one of the tile modules, and the tile modules are capable of displaying the video segments so that the modules collectively reconstitute the video image to form a reconstituted video image.

14. The display of claim 13 wherein the processor and video card are further capable of systematically cycling the plurality of video segments from one tile module to another so that the reconstituted video image, when formed on the display, appears to be moving.

15. A three-dimensional large screen display, comprising:
a three-dimensional mounting structure;
a plurality of electro-optical display tile modules affixed to the mounting structure, each electro-optical display tile module comprising a display surface, an array of optical fibers in optical communication with the display surface, and a micro-display in electronic communication with a video input cable, the plurality of tile modules forming a display surface having a three dimensional shape; and
a computing device in electronic communication with the tile modules, the computing device including a processor and a video card that are capable of apportioning a video image into a plurality of segments and delivering each of the segments to one of the tile modules.

16. The display of claim 15 wherein the processor and video card are further capable of systematically cycling the plurality of video segments from one time module to another so that the reconstituted video image, when formed on the display, appears to be moving.
